(19) United States
(12) Patent Application Publication
(10) Pub. No.: US 2023/0369737 A1
(43) Pub. Date: Nov. 16, 2023

(54) ANTENNA REFLECTOR SPACECRAFT TEMPERATURE REGULATION DURING ORBIT RAISING

(71) Applicant: Maxar Space LLC, Westminster, CO (US)

(72) Inventors: Gordon Chun Kong Wu, Melbourne, FL (US); Joel Boccio, Palo Alto, CA (US); David Marlow, Redwood City, CA (US)

(73) Assignee: Maxar Space LLC, Westminster, CO (US)

(21) Appl. No.: 18/305,190

(22) Filed: Apr. 21, 2023

Related U.S. Application Data
(60) Provisional application No. 63/341,355, filed on May 12, 2022.

(51) Int. Cl. H01Q 1/02; H01Q 1/28; H01Q 1/12; H01Q 15/16

(52) U.S. Cl. CPC H01Q 1/02; H01Q 1/288; H01Q 1/1228; H01Q 15/16

(57) ABSTRACT

Technology is disclosed herein for using an antenna reflector to regulate a spacecraft temperature during orbit raising. When in a launch configuration, the antenna reflector may be stowed in a fairing of a launch vehicle. After the spacecraft is deployed from the launch vehicle and prior to orbit raising, the antenna reflector is moved from the launch configuration to an orbit raising configuration in which the antenna reflector is used to regulate the spacecraft temperature. The antenna reflector may be proximate a thermal radiator panel of the spacecraft when in the launch configuration. The antenna reflector may be positioned such that sunlight will reflect off the antenna reflector onto the thermal radiator panel, thereby warming the spacecraft. After orbit raising, the antenna reflector is moved from the orbit raising configuration to an operational configuration in which a boresight of the antenna reflector may be directed toward nadir.

### PRIORITY DATA

The present application claims priority to U.S. Provisional Patent Application No. 63/341,355, filed on May 12, 2022, entitled “ANTENNA REFLECTOR SPACECRAFT TEMPERATURE REGULATION DURING ORBIT RAISING,” which application is incorporated by reference herein in its entirety.

### BACKGROUND

In some techniques, after a spacecraft is dispensed from the launch vehicle the orbit of the spacecraft is raised. An orbit raising maneuver transfers a spacecraft from one orbit to another orbit. The orbit raising maneuver increases the size and energy of the orbit, which is referred to herein as orbit raising. One example of an orbit raising maneuver is to transfer (or raise) a spacecraft from a low-altitude transfer orbit (or “parking orbit”) to a higher-altitude mission orbit (or “operational orbit”), such as a geosynchronous orbit. For example, after the launch vehicle reaches the launch vehicle transfer orbit, the spacecraft is deployed from the launch vehicle. Then, the spacecraft is raised to its mission orbit such as a geosynchronous orbit. A spacecraft may have an onboard propulsion subsystem to effect such orbit raising.

One technique for orbit raising is to use an electrical propulsion subsystem to raise the orbit, which is referred to as electric orbit raising (EOR). Electric orbit raising requires significant DC power. Also, EOR typically has a relatively long time of flight compared to orbit raising using a chemical propulsion subsystem. The time of flight refers to the time to raise the orbit from, for example, the parking orbit to the operational orbit. However, orbit raising using an electrical propulsion subsystem has advantages over orbit raising using a chemical propulsion subsystem, such as reduced weight and cost.

Regulating the temperature of the spacecraft during orbit raising is technically challenging. In some cases, there is a need to raise the temperature of the spacecraft during orbit raising. One or more of the surfaces (or panels) of the spacecraft may be designed to dissipate heat when the spacecraft is in the operational orbit. When in the operational orbit, internal circuitry for performing the spacecraft's mission contributes to the heat that needs to be dissipated. However, typically the internal circuitry is not used during orbit raising, or at least generates significantly less heat during orbit raising. The temperature of the internal circuitry should remain above a minimum temperature (e.g., above −20 degrees Celsius) during orbit raising. One technique for warming the spacecraft during orbit raising is to use electrically powered heaters. However, in some cases, the spacecraft is operated under battery power for at least a portion of the orbit raising. Hence, using battery power to heat the spacecraft during orbit raising reduces battery life or may require the use of larger and more massive batteries. Moreover, the power that is used for the heaters takes away from the power that could otherwise be used for EOR, which can increase the time of flight.

### BRIEF DESCRIPTION OF THE DRAWINGS

FIG. 1 is a block diagram of a spacecraft system.

FIGS. 2A-2B depict an embodiment of a spacecraft.

FIG. 3 is perspective view of one embodiment of a spacecraft in the launch configuration.

FIGS. 4A and 4B illustrate different embodiments of launch configurations for a spacecraft within a fairing of a launch vehicle.

FIG. 5 is a flowchart of one embodiment of a process of regulating spacecraft temperature during orbit raising.

FIG. 6 depicts one embodiment of the spacecraft with an antenna reflector in the orbit raising configuration.

FIGS. 7A and 7B depict one embodiment of reconfiguring the antenna reflector from the launch configuration into the orbit raising configuration.

FIG. 7C depicts one embodiment of the antenna reflectors in the operational configuration.

FIG. 8A shows an embodiment of a spacecraft in which the antenna reflectors are in the orbit raising configuration with the outer convex surfaces of the respective antenna reflectors facing the body of the spacecraft.

FIG. 8B shows an embodiment of a spacecraft in which the antenna reflectors are in the orbit raising configuration with the inner concave surfaces of the respective antenna reflectors facing the body of the spacecraft.

FIG. 9A shows an embodiment of a spacecraft in which the antenna reflectors are in the orbit raising configuration with the outer convex surfaces of the respective antenna reflectors facing the body of the spacecraft.

FIG. 9B shows an embodiment of a spacecraft in which the antenna reflectors are in the orbit raising configuration with the sun on the east side of the spacecraft.

FIG. 10 is a block diagram of an embodiment of a spacecraft.

### DETAILED DESCRIPTION

Technology is disclosed herein for a spacecraft that is configured to use an antenna reflector to regulate the spacecraft temperature during orbit raising. The antenna reflector may be used to warm the spacecraft during orbit raising. When in a launch configuration, the antenna reflector may be stowed in a fairing of a launch vehicle. After the spacecraft is deployed from the launch vehicle and prior to orbit raising, the antenna reflector is moved from the launch configuration to an orbit raising configuration. During orbit raising, the antenna reflector is used in the orbit raising configuration to regulate the spacecraft temperature. In an embodiment, the antenna reflector is proximate a thermal radiator panel of the spacecraft when in the orbit raising configuration during orbit raising. The term “proximate,” as used throughout this document, means “very near” or “close by.” In some embodiments, the antenna reflector is positioned such that sunlight will reflect off the antenna reflector onto the thermal radiator panel of the spacecraft, thereby warming the spacecraft. Moreover, sunlight that reflects from the thermal radiator panel to the antenna reflector and back to the thermal radiator panel increases the warming of the spacecraft. The term “sunlight,” as used throughout this document, may include both visible and invisible light such as infrared radiation. After orbit raising, the antenna reflector is moved from the orbit raising configuration to an operational configuration. In an embodiment, a boresight of the antenna reflector is directed toward nadir in the operational configuration.

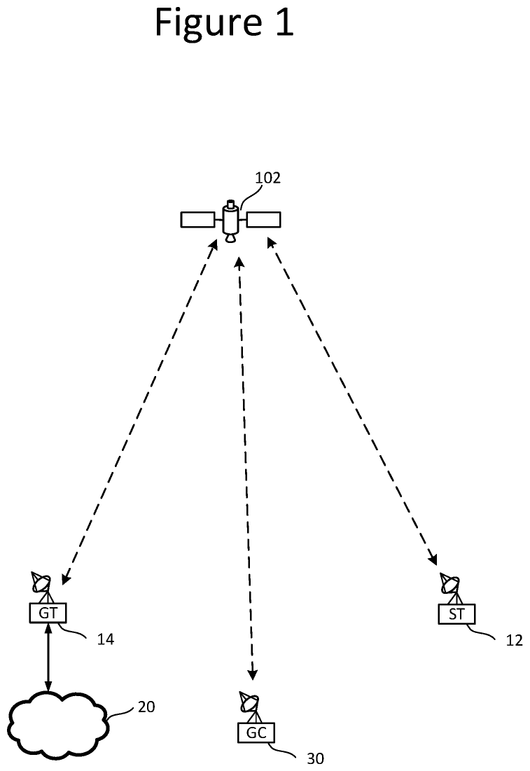

FIG. 1 is a block diagram of a spacecraft system. The system of FIG. 1 includes spacecraft 102, subscriber terminal 12, gateway 14, and ground control terminal 30. Subscriber terminal 12, gateway 14, and ground control terminal 30 are examples of ground terminals. In one embodiment, spacecraft 102 is a satellite; however, spacecraft 102 can be other types of spacecrafts than a satellite. Spacecraft 102 may be in a mission orbit, such as a geostationary or non-geostationary orbital location. Technology disclosed herein may be used for regulating temperature of the spacecraft 102 when raising the orbit of the spacecraft 102.

Spacecraft 102 is communicatively coupled by at least one wireless feeder link to at least one gateway terminal 14 and by at least one wireless user link to a plurality of subscriber terminals (e.g., subscriber terminal 12) via an antenna system. Gateway terminal 14 is connected to the Internet 20. The system allows spacecraft 102 to provide internet connectivity to a plurality of subscriber terminals (e.g., subscriber terminal 12) via gateway 14. Ground control terminal 30 is used to monitor and control operations of spacecraft 102. Spacecraft can vary greatly in size, structure, usage, and power requirements, but when reference is made to a specific embodiment for the spacecraft 102, the example of a communication satellite will often be used in the following, although the techniques are more widely applicable, including other or additional payloads such as for an optical satellite.

The term “main body” as used herein, refers to the nominal major structure of the spacecraft. The main body typically contains the internal payload and bus equipment of the spacecraft and provides structural mounting locations for various external elements, such as solar panels, antenna reflectors, thermal management elements, antenna feeds, launch vehicle mating interfaces, modules, etc.

The term “aft surface” as used herein, refers to the major surface of a spacecraft main body which is furthest aft when the spacecraft is in the launch configuration on a launch vehicle. Aft is defined as being opposite the direction of travel of the launch vehicle. There may be other surfaces which are further aft of the aft surface, such as surfaces on a launch vehicle mating interface, but these are typically much smaller surfaces. The aft surface may be substantially planar, or may be contoured or possess other minor features.

The term “forward surface” as used herein, refers to the major surface of a spacecraft main body which is furthest forward when the spacecraft is in the launch configuration on the launch vehicle. Forward, in this context, is defined as being in the direction of travel of the launch vehicle. It is to be understood that the term “forward surface” does not refer to structures which are movable with respect to the main body, e.g., repositionable reflectors. It is to be further understood that the term forward surface also does not refer to minor surfaces on structures or modules which extend from the forward surface. For example, in some embodiments, a module may extend from the forward surface. The module may possess a substantially smaller cross-sectional area than the forward surface area, i.e., a minor surface. As used herein, the top of such a module should not be construed to constitute the “forward surface.”

The terms “outboard” and “inboard” as used herein, refer to relationships between one element/portion and another element/portion based on their distances from the yaw axis of a spacecraft. For example, if most of component A is located a further perpendicular distance from the yaw axis than most of component B, component A may be said to be “outboard” of component B. Similarly, component B may be said to be “inboard” of component A. There may be some portions of component A which are closer to the yaw axis than some portions of component B, but it will be understood that component A may nonetheless still be substantially outboard of component B.

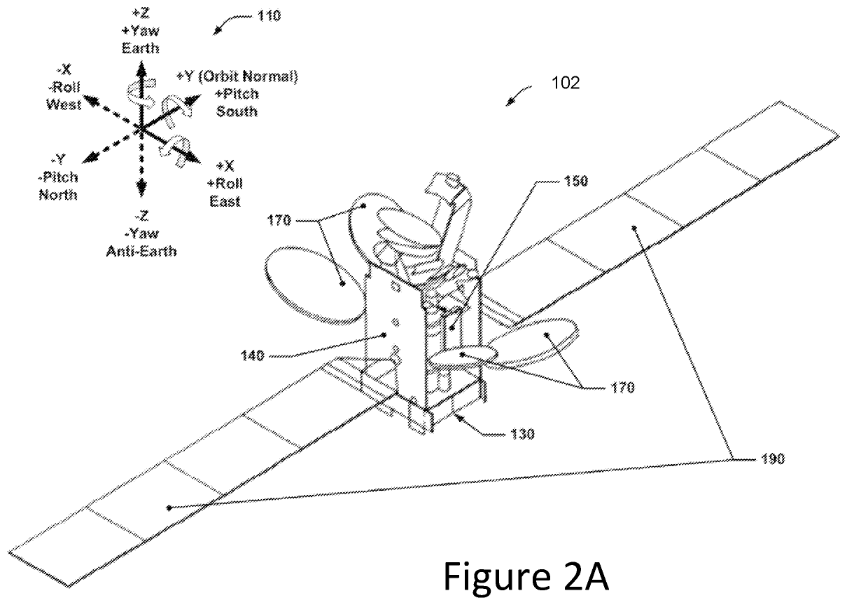

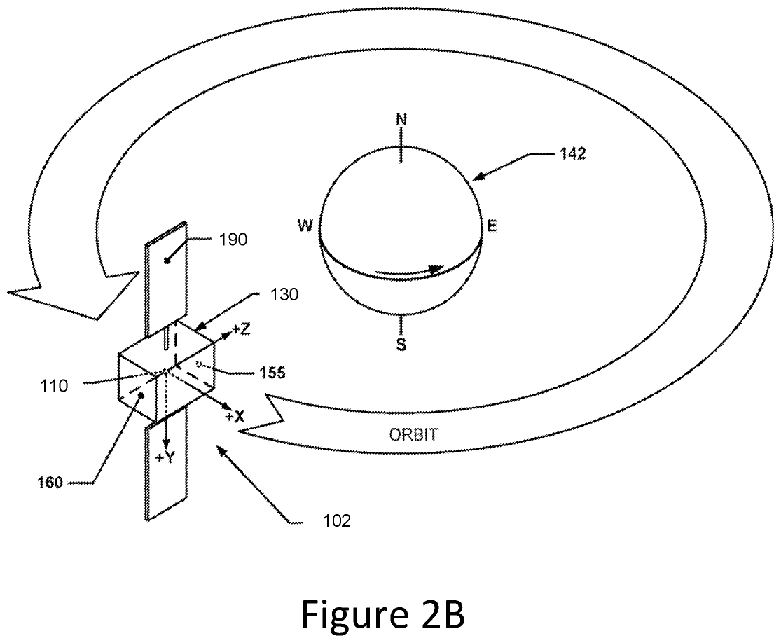

FIGS. 2A-2B depict an embodiment of a spacecraft. A spacecraft, which in some embodiments is a satellite, typically possesses a main body with North (N), South (S), East (E), and West (W) panels which are disposed between and orthogonal to an aft panel and a forward panel of the main body. Each panel is labeled according to the general direction toward which its normal vector is oriented when the satellite is on-orbit. The panels of the N, S, E, and W panels may, generically, also be referred to as side panels, sides, or surfaces. The aft and forward panels may, generically, also be referred to as aft and forward surfaces, respectively. For example, an on-orbit satellite is generally oriented such that normal vectors drawn from the N panel and the S panel are in substantial alignment with the N-S axis of the Earth, with the N panel facing North and the S panel facing South, and such that the normal vectors drawn from the E panel and the W panel are in substantial alignment with the E-W direction.

Satellites may include one or more antenna systems designed to communicate with distant targets, such as locations on Earth. An antenna system may include, for example, an antenna reflector illuminated by a radio-frequency feed (RF feed). The RF feed may transmit and receive RF signals. An antenna reflector has a surface that is configured to reflect electromagnetic waves. In some cases, the surface is parabolic (e.g., dish) shaped, but other shapes may be used. Antenna reflectors are typically configured to reflect electromagnetic waves in a radio frequency wavelength, but may also reflect electromagnetic waves at other wavelengths. Such an antenna reflector may, for example, be an on-axis or off-axis parabolic reflector dish. Other curved shapes may be used for the antenna reflector such as hyperboloid or spheroid. An antenna reflector that is used for a satellite or other spacecraft may sometimes be referred to as a space antenna reflector, but the term antenna reflector will be used herein for brevity.

Antenna reflectors may be either furlable or rigid structures. Furlable antenna reflectors are typically, when unfurled, substantially larger in diameter than the launch vehicle fairing, and are therefore required to be “furled” into a much smaller launch configuration volume.

By way of contrast, rigid antenna reflectors are not designed to unfurl. Instead, they are constructed to maintain their overall shape during stowage, launch, deployment, and on-orbit use. A rigid antenna reflector may be formed from a variety of materials including, but not limited to, metal and graphite, as well as from a combination of materials. A rigid antenna reflector may be capable of flexing and otherwise deforming in minor ways, however the overall shape of a rigid antenna reflector will stay the same. Spacecraft 102 shown in FIG. 2A includes two side-mounted antenna reflectors on the E side and two side mounted antenna reflectors on the W side. Antenna reflectors 170 are depicted in an operational configuration in which they are extended away from east panel 150 and west panel (not shown). In some embodiments, the antenna reflectors 170 are rigid antenna reflectors. The antenna reflectors 170 are configured to reflect electromagnetic energy in a radio frequency wavelength, but may also reflect electromagnetic energy at other wavelengths. For example, the antenna reflectors 170 may reflect electromagnetic energy in the infrared wavelength, the visible wavelength etc.

When an antenna reflector 170 is in the operational configuration a boresight of the antenna is directed towards nadir. The antenna boresight is the axis of maximum gain. An embodiment of an antenna reflector 170 has a parabolic shape. For example, the antenna reflector 170 has a shape of a parabolic dish. For an axial-fed parabolic dish antenna reflector 170, the boresight is the axis of symmetry of the parabolic dish. Other curved shapes may be used for the antenna reflector such as hyperboloid or spheroid. Solar arrays 190 are depicted in an operational configuration in which the arrays are extended away from the north panel 140 and the south panel (not shown).

A better understanding of the reference frames used to describe satellites may be obtained by referring to FIGS. 2A and 2B, wherein an Earth-pointing three axis stabilized satellite 102 is illustrated with respect to a reference spacecraft body coordinate frame 110 having roll (x), pitch (y), and yaw (z) axes. Conventionally, the yaw axis is defined as being directed along a line intersecting Earth 142 center of mass and spacecraft 102 center of mass; the roll axis is defined as being perpendicular to the yaw axis, lying in the plane of the orbit in the direction of the spacecraft velocity vector; and the pitch axis (y), normal to the orbit plane, completes a three-axis, right-hand orthogonal system. Satellite 102 has a main body 130 substantially in the form of a rectangular cuboid. A first panel surface 140, orthogonal to the y-axis, faces generally north when the satellite is in an on-orbit configuration, and may be referred to hereinafter as the north panel. A second panel surface 150, orthogonal to the x-axis, may be referred to hereinafter as the east panel. A third panel surface (not shown), disposed opposite to north panel 140, will be referred to hereinafter as the south panel. A fourth panel surface (not shown), disposed opposite to east panel 150, will be referred to hereinafter as the west panel. In some embodiments, the satellite may have curved sides or otherwise depart from a true rectangular cuboid. In such embodiments, terms east, west, north, and south may still be used to refer to portions of the satellite which generally face in those directions when the satellite is on-orbit.

Referring now to FIG. 2B, satellite 102 may also include Earth deck 155 and anti-Earth deck 160. Conventionally, Earth deck 155 is orthogonal to the z axis and facing earthwards (or towards whatever body the satellite orbits); anti-Earth deck 160 is also orthogonal to the z axis, but facing away from the Earth. Earth deck 155 or anti-Earth deck 160 may have additional separately attached or integrated structures which extend away from either deck.

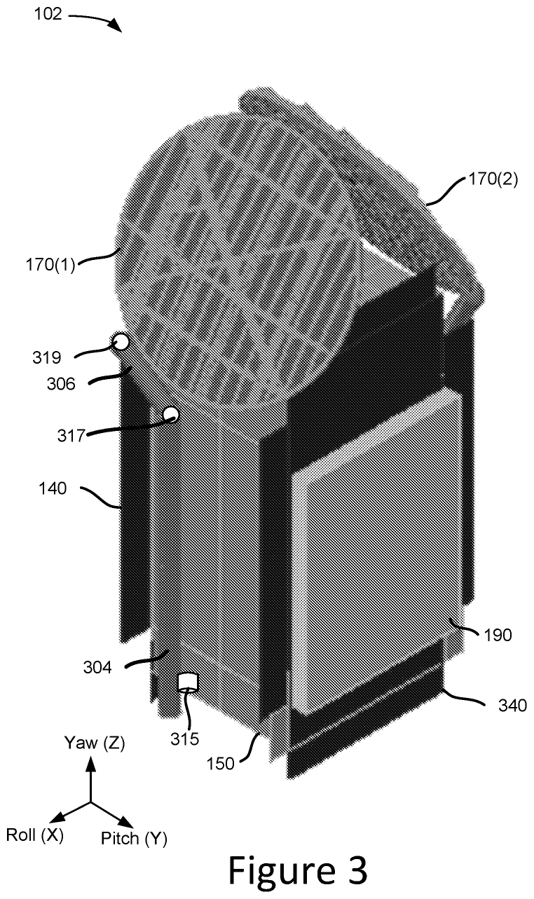

FIG. 3 is a perspective view of one embodiment of a spacecraft 102 in the launch configuration. Two antenna reflectors 170(1) and 170(2) are depicted in an embodiment of a launch configuration. In an embodiment, the antenna reflectors 170 are rigid antenna reflectors. The antenna reflectors 170 may be formed from, but are not limited to, metal, carbon, a combination of materials, etc. In the depicted embodiment, the antenna reflectors 170(1) and 170(2) are stowed above the forward surface of the spacecraft 102. In another embodiment, one antenna reflector 170(1) is stowed proximate the west panel and another antenna reflector 170(2) is stowed proximate the east panel. A solar panel 190 is depicted in the launch configuration proximate the south panel 340. In the launch configuration the solar panel 190 is folded. Stowing the antenna reflectors and solar panels “proximate” or “close to” a panel facilitates fitting the spacecraft into a small volume.

Satellite 102 has an antenna reflector pointing and positioning system (or “APS”) for controlling the position of each respective antenna reflector 170. The antenna reflector pointing and positioning system may be referred to as a “control system” throughout this document. When on orbit, the APS is able to keep the boresight of the antenna reflector pointed to its target. The APS is also able to move the antenna reflector from a launch configuration to an orbit raising configuration, as well as from the orbit raising configuration to an operational configuration.

The APS may include one or more antenna positioning booms, as well as a control circuit configured to control movement of the one or more booms. Each antenna positioning boom may be used to control the position of one of the antenna reflectors 170. In an embodiment, an antenna positioning boom includes two or more positioning mechanisms and one or more boom segments. The control circuit could be implemented with hardware, software, or a combination of hardware and software. The control circuit may be implemented at least in part by executing processor executable instructions on a processer (e.g., a microprocessor). The control circuit may be implemented at least in part by an Application Specific Integrated Circuit (ASIC), FPGA, etc. As one example, a microprocessor issues commands to an FPGA that controls the antenna positioning boom. The APS may use closed loop position control and/or open loop position control.

FIG. 3 depicts an embodiment of the antenna positioning boom that physically moves the antenna reflector 170(1). The APS includes a first antenna positioning boom that is able to position and/or point the first antenna reflector 170(1) and a second antenna positioning boom that is able to position and/or point the second antenna reflector 170(2). The antenna positioning booms operate under control a control circuit (not shown in FIG. 3). The first antenna positioning boom will now be discussed. In an embodiment, the first antenna positioning boom has a first positioning mechanism 315, a second positioning mechanism 317, and a third positioning mechanism 319. The first antenna positioning boom further includes a first boom segment 304 and a second boom segment 306. The boom segments are rigid structures and may be formed from metal, carbon, etc.

The first positioning mechanism 315 is connected to the body of the spacecraft 102. A first boom segment 304 joins the first and second positioning mechanism 315, 317. Specifically, a proximal end of the first boom segment 304 is connected to the first positioning mechanism 315 and a distal end of the first boom segment 304 is connected to the second positioning mechanism 317. A second boom segment 306 joins the second and third positioning mechanism 317, 319. Specifically, a proximal end of the second boom segment 306 is connected to the second positioning mechanism 317 and a distal end of the second boom segment 306 is connected to the third positioning mechanism 319. The third positioning mechanism 319 is connected to the antenna reflector 170(1). The third positioning mechanism 319 may be directly connected to the antenna reflector 170(1) or may be indirectly connected to the antenna reflector 170(1) by another boom segment (not depicted in FIG. 3).

In an embodiment, the positioning mechanisms 315, 317, 319 may each include a gimbal, although another positioning mechanism such as a hinge may be used in one or more of the positioning mechanisms 315, 317, 319. In an embodiment, the gimbals are controlled by a control circuit (not depicted in FIG. 3) to control the position of the antenna reflector 170(1). In an embodiment, a positioning mechanism includes a dual-axis positioning mechanism (DAPM) capable of rotation about two different axes. In an embodiment, a positioning mechanism includes a three-axis positioning mechanism (TAPM) capable of rotation about three different axes. The antenna positioning boom may have additional or fewer boom segments, as well as additional or fewer positioning mechanisms. In an embodiment, positioning mechanism 315 has a hinge and positioning mechanisms 317, 319 each have a two- or three-axis positioning mechanism.

The APS is capable of moving the antenna reflector 170 from the launch configuration (such as, but not limited to the launch configuration in FIG. 3) to an orbit raising configuration. In an embodiment, antenna reflector 170(1) will be proximate to the north panel 140 and antenna reflector 170(2) will be proximate to the south panel 340 when in the orbit raising configuration. Note that the solar panels may first be extended to their respective operational positions prior to moving the antenna reflectors to the orbit raising configuration. For example, the solar panel 190 on the north panel may first be extended to its operational position prior to moving antenna reflector 170(2) to its orbit raising configuration proximate the north panel 340. The positioning mechanisms are also capable of moving the antenna reflectors 170 from their respective orbit raising configurations to operational configurations. In an embodiment, antenna reflector 170(1) will extend away from the east panel 150 when in the operational configuration and antenna reflector 170(2) will extend away from the west panel when in the operational configuration.

When in the orbit raising configuration, the antenna reflectors 170 provide for thermal regulation of the spacecraft 102. In an embodiment, the thermal regulation heats the spacecraft 102. For example, the internal temperature of the spacecraft 102 is increased. In an embodiment, the thermal regulation maintains an internal temperature of the spacecraft 102 at or above a target temperature. In one embodiment, an antenna reflector 170 is proximate to a thermal radiator panel when in the orbit raising configuration. In one embodiment, the north panel 340 and the south panel 140 each serve as thermal radiator panels. Being “proximate” or “close to” a thermal radiator panel facilitates an antenna reflector 170 providing thermal regulation.

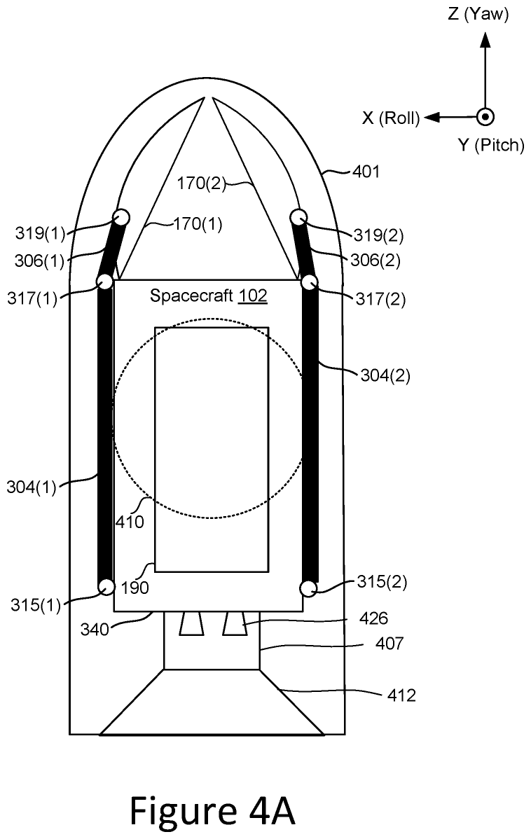

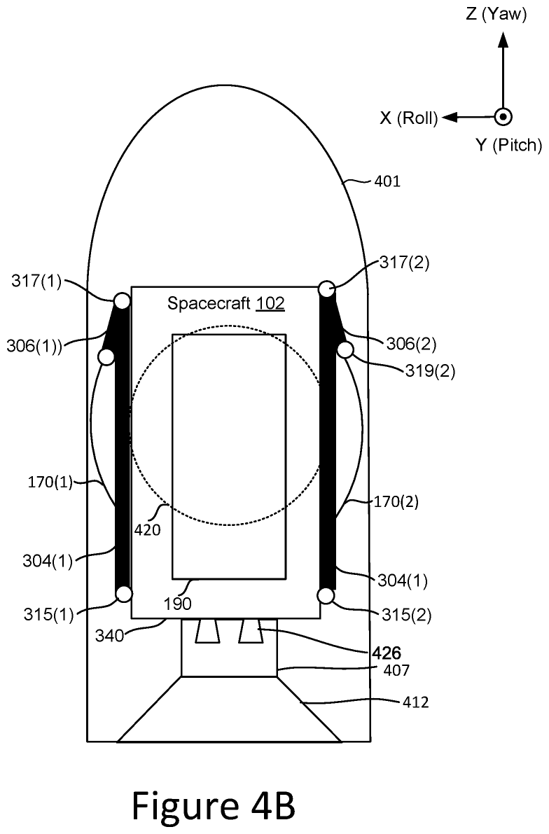

FIG. 4A illustrates an embodiment of a spacecraft in a launch configuration within a fairing 401 of a launch vehicle (not illustrated). The configuration in FIG. 4A may be referred to as a launch configuration. The spacecraft 102 includes an adapter 407 that is mechanically coupled, in the launch configuration, with a primary payload adapter 412 that may be part of an upper stage (not illustrated) of the launch vehicle.

In the embodiment of FIG. 4A the antenna reflectors 170(1), 170(2) are stowed above the forward surface similar to the embodiment depicted in FIG. 3. A dashed circle 410 indicates where the antenna reflector 170(2) will be (e.g., proximate the north panel 340) when in an embodiment of the orbit raising configuration. However, the solar panel 190 will first be moved from the launch configuration depicted in FIG. 4A to an operational configuration (such as depicted in FIG. 2A).

The spacecraft 102 includes one or more on-board propulsion subsystems. In one embodiment, the on-board propulsion subsystem of a spacecraft may be used for orbit raising from, for example, a parking orbit. In one embodiment, an on-board propulsion subsystem may also perform station-keeping to maintain an orbit of a spacecraft. In one embodiment, an on-board propulsion subsystem may also be used for attitude control/momentum management purposes.

In some embodiments, the spacecraft 102 has an electric propulsion subsystem. An electric propulsion subsystem has one or more electric thrusters 426. The electric thruster may be, for example a Hall accelerator, a gridded electrostatic accelerator, a cross field (E×B) accelerator, a pulsed plasma thruster, a pulsed inductive thruster, a field-reversed configuration plasma thruster, a Wakefield accelerator, a traveling wave accelerator, and an ion cyclotron resonance heater combined with a magnetic nozzle. In some embodiments, the electric thrusters are used during orbit raising.

FIG. 4B illustrates another embodiment of a spacecraft in a launch configuration within a fairing 401 of a launch vehicle (not illustrated). In the embodiment of FIG. 4B the antenna reflectors 170(1), 170(2) are stowed proximate to the east panel and the west panel, respectively. Dashed circle 420 indicates where the antenna reflector 170(2) will be (e.g., proximate the north panel 340) when in an embodiment of the orbit raising configuration. The solar panel 190 will first be moved from the launch configuration depicted in FIG. 4B to an operational position (such as depicted in FIG. 2A).

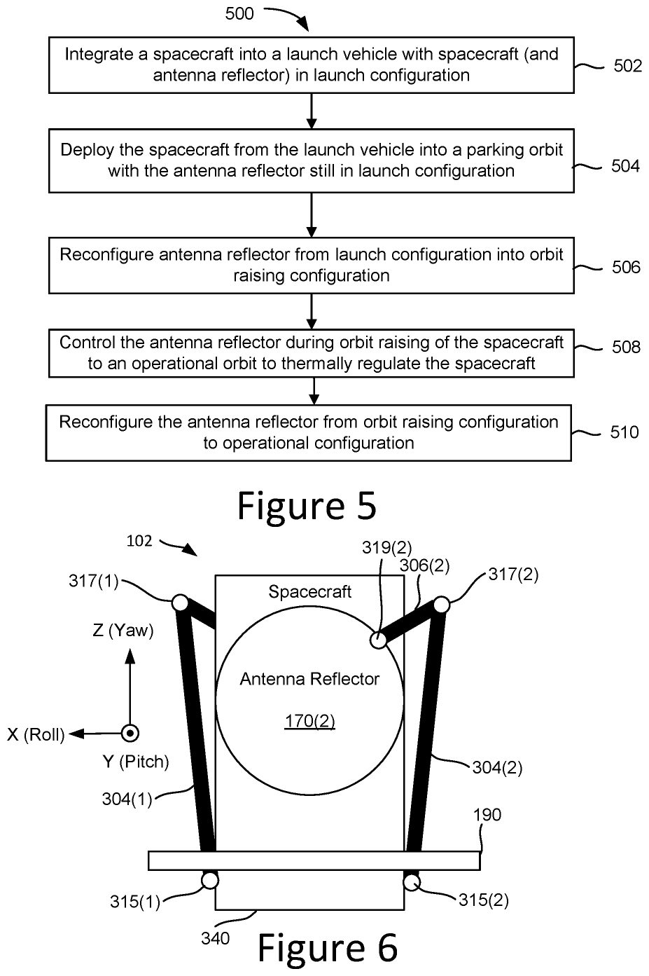

FIG. 5 is a flowchart of one embodiment of a process 500 of regulating spacecraft temperature during orbit raising. Process 500 will be discussed with reference to one antenna reflector 170. However, more than one antenna reflector 170 may be used to regulate the temperature of the spacecraft 102. Steps 504-510 may be performed by one or more control circuits. The one or more control circuits may include circuitry in a spacecraft 102 and/or in ground control 30. The one or more control circuits may be implemented in hardware and/or software.

Step 502 includes integrating a spacecraft 102 into a launch vehicle with the spacecraft and antenna reflector 170 in a launch configuration. In an embodiment, the spacecraft 102 has a forward side, aft side, north side, south side, east side and west side. In one embodiment, the antenna reflector 170 is stowed above and proximate to a forward side (also referred to as forward surface or forward panel) of the spacecraft 102 (see, for example, FIGS. 3, 4A). In one embodiment, the antenna reflector 170 is stowed proximate to either a west side (also referred to as west surface or west panel) or an east side (also referred to as an east surface or east panel) of the spacecraft 102 (see, for example, FIG. 4B). Solar panels are also in a launch configuration. In one embodiment, the solar panel 190 is stowed proximate to either a north side (also referred to as north surface or north panel) or a south side (also referred to as a south surface or south panel) of the spacecraft 102 (see, for example, FIG. 3 or 4A). For the sake of discussion the antenna reflector 170 is stowed proximate a first side of the spacecraft 102 and a solar panel is stowed proximate a second side of the spacecraft 102.

Step 504 includes deploying the spacecraft 102 from the launch vehicle with the antenna reflector 170 still in the launch configuration. The spacecraft 102 may be deployed into a parking orbit following launch of the launch vehicle.

Step 506 includes reconfiguring the spacecraft 102 from the launch configuration into an orbit raising configuration. Step 506 is performed after the spacecraft 102 has been deployed from the launch vehicle. In an embodiment, step 506 is performed when the spacecraft 102 is in a parking orbit. The antenna reflector 170 is in a thermal regulation position when in the orbit raising configuration. In an embodiment, the antenna reflector 170 is moved proximate to a thermal radiator panel. When in the thermal regulation position the antenna reflector 170 may be used to warm the inside of the spacecraft 102 during orbit raising. In an embodiment, the antenna reflector 170 is moved proximate to either the north panel 140 or the south panel 340, which may each serve as a thermal radiator panel. In an embodiment, the antenna reflector 170 is moved proximate to the second side of the spacecraft 102, after moving the solar panel away from the second side. The APS may perform step 506. For example, a control circuit of the APS controls an antenna positioning boom of the APS to re-position the antenna reflector 170.

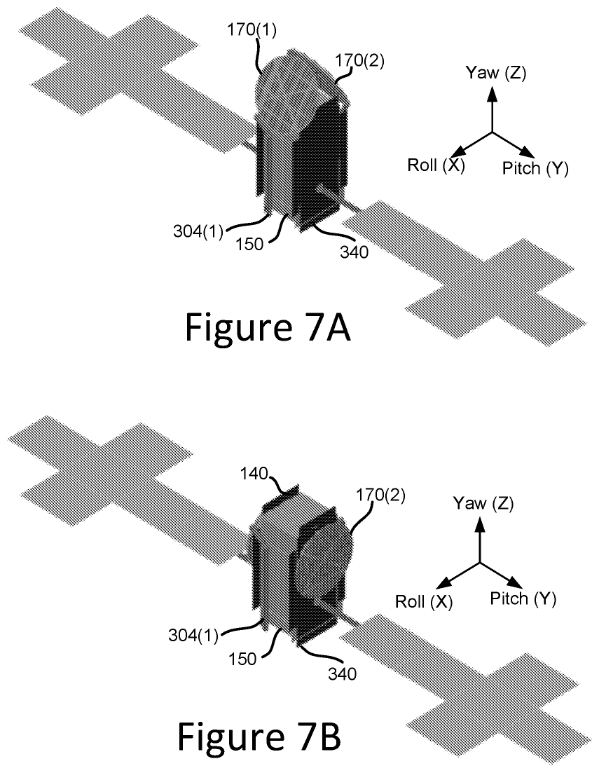

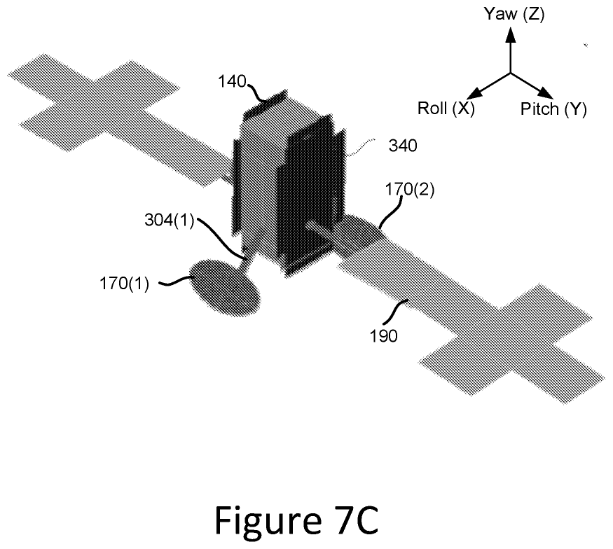

FIG. 6 depicts one embodiment of the spacecraft 102 with antenna reflector 170(2) in the orbit raising configuration. Antenna reflector 170(2) is proximate the north panel 340. The APS is used in step 506 to move the antenna reflector 170(2) from the launch configuration (see, for example, FIG. 3 or 4A) to the orbit raising configuration. In one embodiment, the second positioning mechanism 317(2) and the third positioning mechanism 319(2) are used to move the antenna reflector 170(2) from the launch configuration to the orbit raising configuration. Optionally, the first positioning mechanism 315(2) may be used. The edge of the solar panel 190 can be seen in its operational configuration in which it extends away from the north panel 340 (see FIG. 7B).

FIGS. 7A and 7B depict one embodiment of reconfiguring the antenna reflector 170 from the launch configuration into the orbit raising configuration. FIG. 7A shows the spacecraft 102 with the antenna reflectors 170 still in a launch configuration shortly after deploying the spacecraft from the launch vehicle. However, the solar panels 190 are in the operational configuration. Note that the solar panels 190 may thus be in their operational configuration during orbit raising. FIG. 7B shows that the antenna reflectors 170 are in an orbit raising configuration. Antenna reflector 170(2) is proximate the north panel 340. Antenna reflector 170(1) is proximate the south panel 140. Thus, in one embodiment, step 506 includes first moving the solar panels 190 from the stowed (or launch) configuration to the operational configuration and then moving the antenna reflectors 170 from the stowed (or launch) configuration to the orbit raising configuration.

Returning again to the discussion of FIG. 5, step 508 includes controlling the antenna reflector 170 during orbit raising of the spacecraft to thermally regulate the spacecraft 102. In an embodiment, the thermal regulation includes increasing a temperature inside of the spacecraft 102 during orbit raising. In one embodiment, step 508 includes maintaining the position of the antenna reflector 170 in the same position throughout orbit raising. In some embodiments, the position of the antenna reflector 170 is moved during orbit raising, but stays in the orbit raising configuration in order to thermally regulate the spacecraft 102. The position of the antenna reflector 170 can be changed during orbit raising to control the temperature of the spacecraft. For example, sunlight can strike different sides of the spacecraft during orbit raising. The position of the antenna reflector 170 can be changed to control temperature (e.g., heat the spacecraft 102) in view of the angle of the sunlight. In an embodiment, the thermal regulation includes maintaining a temperature inside of the spacecraft 102 during orbit raising at or above a target temperature. The target temperature may be a minimum operating temperature of circuitry inside of the spacecraft 102.

In one embodiment, the spacecraft 102 is raised from a parking orbit to an operational orbit (also referred to as mission orbit). In one embodiment, step 508 includes EOR, which uses electric thrusters 426. Step 508 can include a combination of EOR and using a chemical propulsion subsystem for orbit raising. In some embodiments, the time of flight for EOR can be reduced by using additional power for EOR due to power savings from using less power to warm the spacecraft 102.

Step 510 includes reconfiguring the spacecraft 102 from the orbit raising configuration to an operational configuration. Step 510 is performed after the spacecraft 102 has been raised to its operational orbit. Step 510 may include orienting the antenna reflector 170 such that a boresight of the antenna reflector 170 is directed toward nadir. The APS is used in step 510 to move the antenna reflector 170(2) from the orbit raising configuration to the operational configuration. In an embodiment, the first boom segment 304 is extended away from either the east panel 150 or the west panel to place the antenna reflector 170 into the operational configuration. In an embodiment, the first positioning mechanism 315 is used to move first boom segment 304 in order to move the antenna reflector 170 away from the body of the spacecraft. The second positioning mechanism 317 and/or the third positioning mechanism 319 may also be used to achieve the operational configuration. FIG. 7C depicts one embodiment of the antenna reflectors 170 in the operational configuration. FIG. 7C shows that the first boom segment 304(1) is extended away from the east panel 150 to place the antenna reflector 170(1) into the operational configuration. Antenna reflector 170(2) is depicted extending away from the west panel to place the antenna reflector 170(2) into the operational configuration.

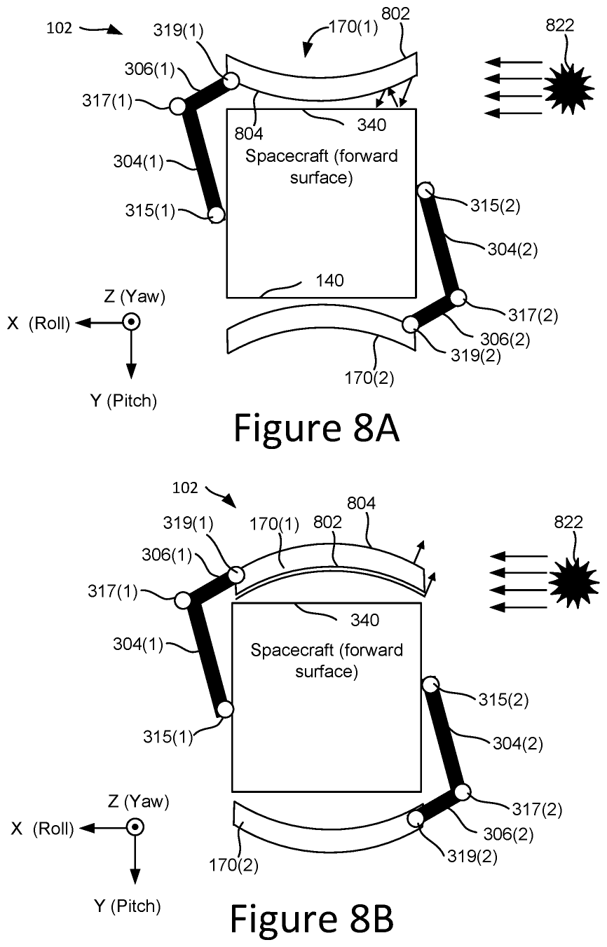

In an embodiment, the antenna reflector 170 has a parabolic shape. In an embodiment, the antenna reflector 170 has a curved inner surface and a curved outer surface. When in the orbit raising configuration either the curved inner surface or the curved outer surface may face the body of the spacecraft 102. FIG. 8A shows an embodiment of a spacecraft 102 in which the antenna reflectors 170 are in the orbit raising configuration with the curved outer surfaces 804 of the respective antenna reflectors 170 facing the body of the spacecraft 102. Stated another way, the antenna boresight is directed away from the body of the spacecraft 102. In FIG. 8A, the view is looking down at the forward surface of the spacecraft 102. The sun 822 is depicted on the west side of the spacecraft 102. Light from the sun may reflect off from the curved outer surface 804 of the antenna reflector 170(1) onto the north panel 340 of the spacecraft 102. Moreover, sunlight that reflects off from the north panel 340 of the spacecraft 102 may reflect to the curved outer surface 804 of the antenna reflector 170(1) and back to the north panel 340. As noted above, the north panel 340 may serve as a thermal radiator panel. Therefore, the antenna reflector 170(1) may warm the spacecraft 102. In a similar manner, antenna reflector 170(2) may reflect sunlight onto the south panel 140 to thereby warm the spacecraft 102. This warming may include increasing an internal temperature of the spacecraft 102. Therefore, the temperature of internal circuitry is kept at or above a minimum operating temperature during orbit raising.

FIG. 8B shows an embodiment of a spacecraft 102 in which the antenna reflectors 170 are in the orbit raising configuration with the inner surfaces 802 of the respective antenna reflectors 170 facing the body of the spacecraft 102. Stated another way, the antenna boresight is directed towards the body of the spacecraft 102. In FIG. 8B, the view is looking down at the forward surface of the spacecraft 102. The sun 822 is depicted on the west side of the spacecraft 102. In an embodiment, the sunlight may be trapped between the curved inner surface 802 of antenna reflector 170(1) to warm the spacecraft 102. Likewise, the sunlight may be trapped between the curved inner surface 802 of antenna reflector 170(2) to warm the spacecraft 102.

Note that during orbit raising an antenna reflector 170 may be moved from the curved outer surface 804 facing the body configuration to the curved inner surface 802 facing the body configuration, as well as from the curved inner surface 802 facing the body configuration to the curved outer surface 804 facing the body configuration. For example, one or more of the positioning mechanisms 315, 317, 319 may be used to move the antenna reflector 170 between these two configurations. For example, second positioning mechanism 317(1) and/or third positioning mechanism 319(1) may be controlled by the APS to move the antenna reflector 170(1) between these two configurations. Optionally, the first positioning mechanism 315(1) may be used in addition to the second positioning mechanism 317(1) and/or third positioning mechanism 319(1).

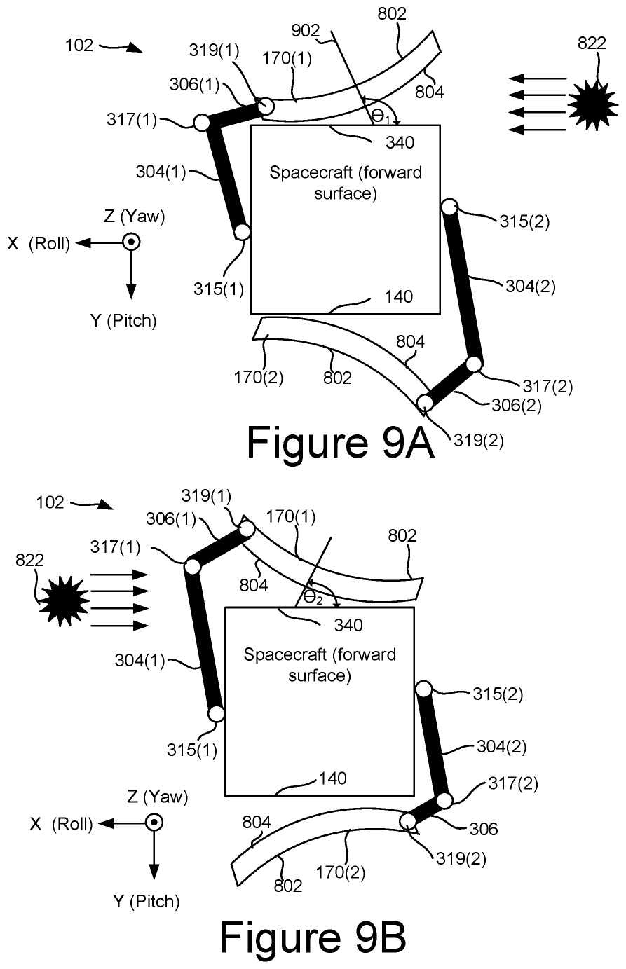

In an embodiment, the angle of a surface of the antenna reflector 170 with respect to a panel is controlled for thermal regulation of the spacecraft. For example, an angle of an axis of symmetry of a parabolic shape of the antenna reflector 170 to a surface of the spacecraft is controlled for thermal regulation of the spacecraft. This thermal regulation may increase an internal temperature of the spacecraft 102. FIG. 9A shows an embodiment of a spacecraft 102 in which the antenna reflectors 170 are in the orbit raising configuration with the outer surfaces 804 of the respective antenna reflectors 170 facing the body of the spacecraft 102. The view is similar to the one of FIG. 8A, looking down at the forward surface of the spacecraft 102. The sun 822 is depicted on the west side of the spacecraft 102. The curved outer surface 804 of antenna reflector 170(1) is facing the north panel 340 such that the antenna reflector 170(1) is positioned to reflect sunlight onto the north panel 340 to warm the spacecraft 102. Stated another way, the antenna boresight is directed away from the north panel 340. The axis of symmetry 902 of the antenna reflector 170(1) is depicted to show an angle (θ₁) between the axis of symmetry 902 and the north panel 340. The curved outer surface 804 of antenna reflector 170(2) is facing the south panel 140 such that the antenna reflector 170(2) is positioned to reflect sunlight onto the south panel 140 to warm the spacecraft 102. Moreover, the respective outer surfaces 804 are angled for thermal regulation of the spacecraft 102. That is, the amount of heating is controlled based on the angle of the curved outer surface 804.

FIG. 9B shows an embodiment of a spacecraft 102 in which the antenna reflectors 170 are in the orbit raising configuration with the sun 822 on the east side of the spacecraft 102. The view is similar to the one of FIG. 9A, looking down at the forward surface of the spacecraft 102. However, the sun 822 is depicted on the east side of the spacecraft 102. As in the example of FIG. 9A, the curved outer surface 804 of antenna reflector 170(1) is facing the north panel 340 such that the antenna reflector 170(1) is positioned to reflect sunlight onto the north panel 340 to warm the spacecraft 102. The axis of symmetry 902 of the antenna reflector 170(1) is depicted to show an angle (θ₂) between the axis of symmetry 902 and the north panel 340. Likewise, the curved outer surface 804 of antenna reflector 170(2) is facing the south panel 140 such that the antenna reflector 170(2) is positioned to reflect sunlight onto the south panel 140 to warm the spacecraft 102. The respective outer surfaces 804 are angled for thermal regulation of the spacecraft 102. That is, the amount of heating is controlled based on the angle of the respective outer surfaces 804. However, the respective outer surfaces 804 are angled in a different manner than in the example of FIG. 9A. Stated another way, the angles (θ₁, θ₂) between the axis of symmetry 902 and the north panel 340 are different to provide thermal regulation based on the direction of the sunlight.

In an embodiment, the positioning mechanisms of the antenna positioning boom are used to control the angle between the axis of symmetry 902 of an antenna reflector 170 and a panel. For example, one or more of the positioning mechanisms 315, 317, 319 may be used to control the angle between the axis of symmetry 902 of an antenna reflector 170 and a panel. For example, second positioning mechanism 317(1) and/or third positioning mechanism 319(1) may be controlled by the APS to control the angle between the axis of symmetry 902 of antenna reflector 170(1) and the north panel 340. Optionally, the first positioning mechanism 315(1) may be used in addition to the second positioning mechanism 317(1) and/or third positioning mechanism 319(1).

In an embodiment, the antenna reflector 170 has a central portion and peripheral portions. In an embodiment, the axis of symmetry 902 runs through the central portion. In an embodiment, the peripheral portions are at the outer edges of the parabolic dish. With reference to FIGS. 9A and 9B, the antenna reflector 170 may be positioned such that one part of the peripheral portion is closer to the spacecraft body than the central portion and another part of the peripheral portion is farther from the spacecraft body than the central portion. Therefore, sunlight may be reflected by the antenna reflector 170 onto the thermal radiator panel (e.g., north panel 340 or south panel 140) to thereby heat the spacecraft 102.

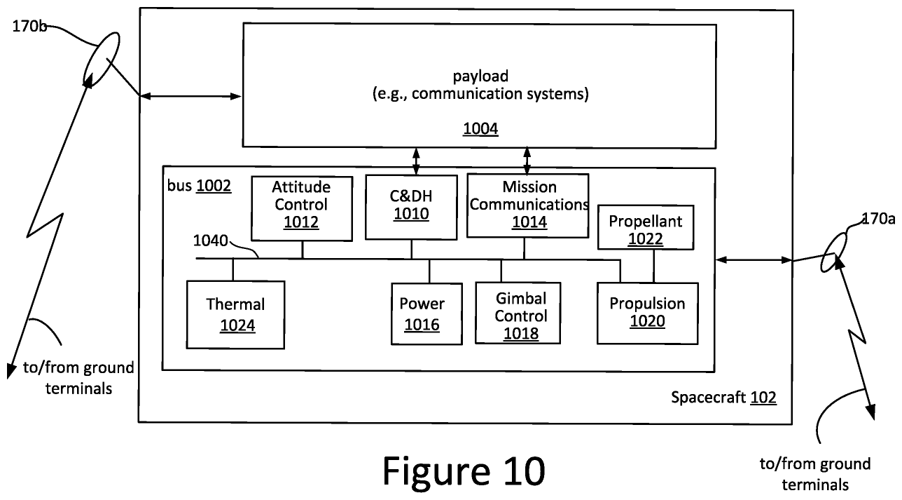

FIG. 10 is a block diagram of one embodiment of spacecraft 102, which in one example (as discussed above) is a satellite. In one embodiment, spacecraft 102 includes a bus 1002 and a payload 1004 carried by bus 1002. Some embodiments of spacecraft 102 may include more than one payload. The payload provides the functionality of communication, sensors and/or processing systems needed for the mission of spacecraft 102.

In general, bus 1002 is the spacecraft that houses and carries the payload 1004, such as the components for operation as a communication satellite. The bus 1002 includes a number of different functional sub-systems or modules, some examples of which are shown. Each of the functional sub-systems typically include electrical systems, as well as mechanical components (e.g., servos, actuators, motors) controlled by the electrical systems. These include a command and data handling sub-system (C&DH) 1010, attitude control systems 1012, mission communication systems 1014, power subsystems 1016, gimbal control electronics 1018 that may include a solar array drive assembly and an antenna reflector drive assembly, a propulsion subsystem 1020 (e.g., thrusters), propellant storage 1022 to fuel some embodiments of propulsion subsystem 1020, and thermal control subsystem 1024, all of which are connected by an internal communication network 1040, which can be an electrical bus (a “flight harness”) or other means for electronic, optical or RF communication when spacecraft is in operation. In some embodiments the propulsion subsystem 1020 is used for orbit raising, as disclosed herein.

Also represented are an antenna 170a, that is one of one or more antennae used by the mission communication systems 1014 for exchanging communications for operating of the spacecraft with ground terminals, and a payload antenna 170b, that is one of one or more antennae used by the payload 1004 for exchanging communications with ground terminals, such as the antennae used by a communication satellite embodiment. Other equipment can also be included.

The gimbal control electronics 1018 may be used in the APS to control the position of the antenna reflectors 170a, 170b. In an embodiment, the gimbal control 1018 includes an antenna positioning boom that is able to move an antenna reflector 170 from a launch configuration to an orbit raising configuration, as well as from the orbit raising configuration to an operational configuration. The gimbal control electronics 1018 may include a control circuit that is configured to control the antenna positioning boom in order to control the position of the antenna reflector 170. The gimbal control electronics 1018 may include one or more DC motors. The one or more DC motors may be part of the antenna positioning boom or separate from the antenna positioning boom. The gimbal control electronics 1018 could be implemented with hardware, software, or a combination of hardware and software. The gimbal control electronics 1018 may be implemented at least in part by executing processor executable instructions on a processer (e.g., a microprocessor). The gimbal control electronics 1018 may be implemented at least in part by an Application Specific Integrated Circuit (ASIC), FPGA, etc. As one example, the gimbal control electronics 1018 includes a microprocessor that issues commands to an FPGA that controls the antenna positioning boom.

The command and data handling module 1010 includes any processing unit or units for handling command control functions for spacecraft 102, such as for attitude control functionality and orbit control functionality. The attitude control systems 1012 can include devices including torque rods, wheel drive electronics, and control momentum gyro control electronics, for example, that are used to monitor and control the attitude of the spacecraft. Mission communication systems 1014 includes wireless communication and processing equipment for receiving telemetry data/commands, other commands from the ground control terminal 30 to the spacecraft and ranging to operate the spacecraft. Processing capability within the command and data handling module 1010 is used to control and operate spacecraft 102. An operator on the ground can control spacecraft 102 by sending commands via ground control terminal 30 to mission communication systems 1014 to be executed by processors within command and data handling module 1010. In one embodiment, command and data handling module 1010 and mission communication system 1014 are in communication with payload 1004. In some example implementations, bus 1002 includes one or more antennae as indicated at 1043 connected to mission communication system 1014 for wirelessly communicating between ground control terminal 30 and mission communication system 1014. Power subsystems 1016 can include one or more solar panels and charge storage (e.g., one or more batteries) used to provide power to spacecraft 102. Propulsion subsystem 1020 (e.g., thrusters) is used for changing the position or orientation of spacecraft 102 while in space to move into orbit, to change orbit or to move to a different location in space. The gimbal control electronics 1018 can be used to move and align the antennae, solar panels, and other external extensions of the spacecraft 102.

In one embodiment, the payload 1004 is for a communication satellite and includes an antenna system (represented by the antenna 170) that provides a set of one or more beams (e.g., spot beams) comprising a beam pattern used to receive wireless signals from ground stations and/or other spacecraft, and to send wireless signals to ground stations and/or other spacecraft. In some implementations, mission communication system 1014 acts as an interface that uses the antennae of payload 1004 to wirelessly communicate with ground control terminal 30. In other embodiments, the payload could alternately or additionally include an optical payload, such as one or more telescopes or imaging systems along with their control systems, which can also include RF communications to provide uplink/downlink capabilities.

The components connected to the bus 1002 may by themselves, or in combination with components in ground control 30, be referred to as one or more control circuits. The one or more control circuits may comprise hardware and/or software. The one or more control circuits may be implemented at least in part by executing processor executable instructions on a processer (e.g., a microprocessor). The one or more control circuits may be implemented at least in part by an Application Specific Integrated Circuit (ASIC), FPGA, etc.

A first embodiment includes a body comprising a plurality of sides, an antenna reflector having a boresight, an antenna positioning boom connected between the body and the antenna reflector, and one or more control circuits in communication with the antenna positioning boom. The one or more control circuits are configured to control the antenna positioning boom to move the antenna reflector from a launch configuration to an orbit raising configuration after the spacecraft is deployed from a launch vehicle and prior to orbit raising of the spacecraft. In the launch configuration the antenna reflector is proximate a first side of the plurality of sides. In the orbit raising configuration the antenna reflector is proximate to a second side of the plurality of sides such that the antenna reflector is positioned for thermal regulation of the spacecraft. The one or more control circuits are configured to control the antenna positioning boom in the orbit raising configuration to thermally regulate the spacecraft during orbit raising. The one or more control circuits are configured to control the antenna positioning boom to move the antenna reflector from the orbit raising configuration to an operational position in which the boresight of the antenna reflector is directed toward nadir.

In a further embodiment, the antenna reflector comprises a curved shape having a curved inner surface and a curved outer surface. The one or more control circuits are configured to control the antenna positioning boom to orient the curved inner surface towards the second side when in the orbit raising configuration.

In a further embodiment, the antenna reflector comprises a curved shape having a curved inner surface and a curved outer surface. The one or more control circuits are configured to control the antenna positioning boom to orient the curved outer surface towards the second side when in the orbit raising configuration.

In a further embodiment, the antenna reflector comprises a surface. The one or more control circuits are configured to control the antenna positioning boom to control an angle of the surface with respect to the second side when in the orbit raising configuration to cause the surface to reflect sunlight onto the second side to maintain a temperature inside of the spacecraft at or above a target temperature.

In a further embodiment, the surface comprises a parabolic shape.

In a further embodiment, the one or more control circuits are configured to control the antenna positioning boom to orient the antenna reflector to increase an internal temperature of the spacecraft when in the orbit raising configuration.

In a further embodiment, the second side comprises a thermal radiator panel.

In a further embodiment, the spacecraft further comprises a solar panel having a launch position in which the solar panel is folded and proximate to the second side and an orbit raising configuration in which the solar panel in unfolded and extends perpendicular to the second side. The one or more control circuits are configured to control the antenna positioning boom to move the antenna reflector from the launch configuration to the orbit raising configuration after the solar panel is moved to the orbit raising configuration.

In a further embodiment, the plurality of sides comprise a north side, a south side, an east side, a west side, a forward side, and an aft side. The second side is one of: the north side and the south side. By this it is meant that either the second side is the north side or, alternatively, the second side is the south side. In other words, one option that when in the orbit raising configuration the antenna reflector is proximate to the north side of the spacecraft such that the antenna reflector is positioned for thermal regulation of the spacecraft and another option is that when in the orbit raising configuration the antenna reflector is proximate to the south side of the spacecraft such that the antenna reflector is positioned for thermal regulation of the spacecraft.

In a further embodiment, when in the launch configuration the antenna reflector is proximate the forward side.

In a further embodiment, when in the launch configuration the antenna reflector is proximate one of: the east side and the west side. By this it is meant that either the antenna reflector is proximate to the east side or, alternatively, the antenna reflector is proximate to the west side. In other words, one option that when in the launch configuration the antenna reflector is proximate the east side of the spacecraft and another option is that when in the launch configuration the antenna reflector is proximate the west side of the spacecraft.

One embodiment includes a method for operating a spacecraft, the method comprising deploying a spacecraft from a fairing of a launch vehicle into a parking orbit. Prior to deployment the spacecraft is in a launch configuration with an antenna reflector stowed proximate a first side of the spacecraft and after deployment the antenna reflector remains stowed proximate the first side. The method comprises reconfiguring the spacecraft from the launch configuration to an orbit raising configuration, including moving the antenna reflector from proximate the first side to proximate a second side of the spacecraft such that the antenna reflector is positioned for thermal regulation of the spacecraft. The method comprises controlling the position of the antenna reflector proximate the second side of the spacecraft during orbit raising of the spacecraft to an operational orbit to maintain a temperature inside of the spacecraft at or above a target temperature

The method comprises reconfiguring the spacecraft from the orbit raising configuration to an operational configuration, including moving the antenna reflector away from the second side to an orientation such that a boresight of the antenna reflector is directed toward nadir.

One embodiment includes a satellite comprising a body comprising a thermal radiator panel and an antenna reflector having a parabolic shape. The parabolic shape has an axis of symmetry. The satellite comprises an antenna positioning boom comprising positioning mechanisms. The antenna positioning boom is connected between the body and the antenna reflector. The satellite comprises one or more control circuits in communication with the positioning mechanisms. The one or more control circuits are configured to control the positioning mechanisms to move the antenna reflector from a launch configuration to an orbit raising configuration after the satellite is deployed from a fairing of a launch vehicle. In the launch configuration the antenna reflector is stowed in the fairing of the launch vehicle, wherein in the orbit raising configuration the antenna reflector is proximate to the thermal radiator panel such that the antenna reflector is positioned for warming of the satellite. The one or more control circuits are configured to control the positioning mechanisms to control the position of the antenna reflector proximate to the thermal radiator to warm the satellite during orbit raising of the satellite. The one or more control circuits are configured to control the positioning mechanisms to move the antenna reflector from the orbit raising configuration to an operational configuration after the orbit has been raised to the operational orbit, wherein in the operational configuration the antenna reflector is configured for signal transmission between the satellite and one or more sources on Earth.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope of be defined by the claims appended hereto.

What is claimed is:

1. A spacecraft comprising:
a body comprising a plurality of sides;
an antenna reflector having a boresight;
an antenna positioning boom connected between the body and the antenna reflector; and
one or more control circuits in communication with the antenna positioning boom, wherein the one or more control circuits are configured to:
control the antenna positioning boom to move the antenna reflector from a launch configuration to an orbit raising configuration after the spacecraft is deployed from a launch vehicle and prior to orbit raising of the spacecraft, wherein in the launch configuration the antenna reflector is proximate a first side of the plurality of sides, wherein in the orbit raising configuration the antenna reflector is proximate to a second side of the plurality of sides such that the antenna reflector is positioned for thermal regulation of the spacecraft;
control the antenna positioning boom in the orbit raising configuration to thermally regulate the spacecraft during orbit raising; and
control the antenna positioning boom to move the antenna reflector from the orbit raising configuration to an operational configuration after the orbit of the spacecraft has been raised to an operational orbit, wherein the boresight of the antenna reflector is directed toward nadir when in the operational configuration.

2. The spacecraft of claim 1, wherein:
the antenna reflector comprises a curved shape having a curved inner surface and a curved outer surface; and
the one or more control circuits are configured to control the antenna positioning boom to orient the curved inner surface towards the second side when in the orbit raising configuration to thermally regulate the spacecraft during orbit raising.

3. The spacecraft of claim 1, wherein:
the antenna reflector comprises a curved shape having a curved inner surface and a curved outer surface; and
the one or more control circuits are configured to control the antenna positioning boom to orient the curved outer surface towards the second side when in the orbit raising configuration to thermally regulate the spacecraft during orbit raising.

4. The spacecraft of claim 1, wherein:
the antenna reflector comprises a surface; and
the one or more control circuits are configured to control the antenna positioning boom to control an angle of the surface with respect to the second side when in the orbit raising configuration during orbit raising of the spacecraft to cause the surface to reflect sunlight onto the second side to maintain a temperature inside of the spacecraft at or above a target temperature.

5. The spacecraft of claim 4, wherein the surface comprises a parabolic shape.

6. The spacecraft of claim 1, wherein one or more control circuits are configured to control the antenna positioning boom to orient the antenna reflector to increase an internal temperature of the spacecraft when in the orbit raising configuration during orbit raising of the spacecraft.

7. The spacecraft of claim 6, wherein the second side comprises a thermal radiator panel.

8. The spacecraft of claim 1, further comprising:
a solar panel having a launch position in which the solar panel is folded and proximate to the second side and an orbit raising configuration in which the solar panel in unfolded and extends perpendicular to the second side, wherein one or more control circuits are configured to control the antenna positioning boom to move the antenna reflector from the launch configuration to the orbit raising configuration after the solar panel is moved to the orbit raising configuration.

9. The spacecraft of claim 1, wherein:
the plurality of sides comprise a north side, a south side, an east side, a west side, a forward side, and an aft side; and
the second side is one of: the north side and the south side.

10. The spacecraft of claim 9, wherein when in the launch configuration the antenna reflector is proximate the forward side.

11. The spacecraft of claim 9, wherein when in the launch configuration the antenna reflector is proximate one of: the east side and the west side.

12. A method for operating a spacecraft, the method comprising:
deploying a spacecraft from a fairing of a launch vehicle into a parking orbit, wherein prior to deployment the spacecraft is in a launch configuration with an antenna reflector stowed proximate a first side of the spacecraft and after deployment the antenna reflector remains stowed proximate the first side;
reconfiguring the spacecraft from the launch configuration to an orbit raising configuration after deploying the spacecraft, including moving the antenna reflector from proximate the first side to proximate a second side of the spacecraft such that the antenna reflector is positioned for thermal regulation of the spacecraft;
controlling the position of the antenna reflector proximate the second side of the spacecraft during orbit raising of the spacecraft to an operational orbit to maintain a temperature inside of the spacecraft at or above a target temperature; and
reconfiguring the spacecraft from the orbit raising configuration to an operational configuration after reaching the operational orbit, including moving the antenna reflector away from the second side to an orientation such that a boresight of the antenna reflector is directed toward nadir.

13. The method of claim 12, wherein moving the antenna reflector from proximate the first side to proximate the second side of the spacecraft such that the antenna reflector is positioned for thermal regulation of the spacecraft comprises:
moving the antenna reflector to one of: a north panel and a south panel of the spacecraft.

14. The method of claim 12, wherein moving the antenna reflector from proximate the first side to proximate the second side of the spacecraft such that the antenna reflector is positioned for thermal regulation of the spacecraft comprises:
controlling an angle of a surface of the antenna reflector with respect to the second side when in the orbit raising configuration to cause the surface to reflect sunlight onto the second side.

15. A satellite comprising:
a body comprising a thermal radiator panel;
an antenna reflector having a parabolic shape, the parabolic shape having an axis of symmetry;
an antenna positioning boom comprising positioning mechanisms, wherein the antenna positioning boom is connected between the body and the antenna reflector; and
one or more control circuits in communication with the positioning mechanisms, wherein the one or more control circuits are configured to:
control the positioning mechanisms to move the antenna reflector from a launch configuration to an orbit raising configuration after the satellite is deployed from a fairing of a launch vehicle, wherein in the launch configuration the antenna reflector is stowed in the fairing of the launch vehicle, wherein in the orbit raising configuration the antenna reflector is proximate to the thermal radiator panel such that the antenna reflector is positioned for warming of the satellite;
control the positioning mechanisms to control the position of the antenna reflector proximate to the thermal radiator to warm the satellite during orbit raising of the satellite; and
control the positioning mechanisms to move the antenna reflector from the orbit raising configuration to an operational configuration after the orbit has been raised to the operational orbit, wherein in the operational configuration the antenna reflector is configured for signal transmission between the satellite and one or more sources on Earth.

16. The satellite of claim 15, wherein:
the parabolic shape has an inner surface and an outer surface; and
the one or more control circuits are configured to control the positioning mechanisms to orient the inner surface to face the thermal radiator panel to increase an internal temperature of the satellite while the antenna reflector is in the orbit raising configuration during orbit raising.

17. The satellite of claim 15, wherein:
the parabolic shape has an inner surface and an outer surface; and
the one or more control circuits are configured to control the positioning mechanisms to orient the outer surface to face the thermal radiator panel to increase an internal temperature of the satellite while the antenna reflector is in the orbit raising configuration during orbit raising.

18. The satellite of claim 17, wherein the one or more control circuits are configured to control the positioning mechanisms to control an angle of the axis of symmetry of the parabolic shape with respect to the thermal radiator panel when in the orbit raising configuration during orbit raising to maintain a temperature inside of the satellite at or above a target temperature.

19. The satellite of claim 17, wherein the one or more control circuits are configured to control the positioning mechanisms to control an angle of the axis of symmetry of the parabolic shape with respect to the thermal radiator panel when the antenna reflector is in the orbit raising configuration during orbit raising based on a direction of sunlight received at the satellite to cause sunlight to reflect off from the outer surface of the parabolic shape and onto the thermal radiator panel to increase an internal temperature of the satellite.

20. The satellite of claim 15, further comprising:
a solar panel having a launch configuration in which the solar panel is folded and proximate to the thermal radiator panel and an operational configuration in which the solar panel is unfolded and extends away from the thermal radiator panel;
wherein the one or more control circuits are configured to control the positioning mechanisms to move the antenna reflector from the launch configuration to the orbit raising configuration after the solar panel is in the operational configuration.
